(19) United States
(12) Patent Application Publication
(10) Pub. No.: US 2011/0134398 A1
(43) Pub. Date: Jun. 9, 2011

(54) Projection System

(75) Inventor: Chien-Chiang Hsu, Taoyuan County (TW)

(73) Assignee: QISDA CORPORATION, Taoyuan County (TW)

(21) Appl. No.: 12/959,405

(22) Filed: Dec. 3, 2010

(30) Foreign Application Priority Data
Dec. 4, 2009 (TW) 098141541

(51) Int. Cl. G03B 21/28; G03B 21/14

(52) U.S. Cl. 353/81; 353/97

(57) ABSTRACT

The invention discloses a projection system including a light source, a light gathering device, an imaging device, and a projection lens. The light source is used for emitting a first light, and the light gathering device includes an aperture and a lens for receiving the first light in sequence and producing a second light. The imaging device includes a field lens and a reflective valve near the field lens, and the field lens and the reflective valve are used for receiving the second light in sequence and producing an exit pupil. The projection lens has an entrance pupil, and the entrance pupil substantially overlaps the exit pupil.

### BACKGROUND OF THE INVENTION

1. Field of the Invention

The present invention generally relates to a projection system. Particularly, the present invention relates to a projection system using a field lens to improve light use efficiency.

2. Description of the Prior Art

Projection systems are widely used in government, business, and schools. Because the size of projected image is dependent on the distance between the projection system and the screen/wall based on the function of projecting. Compared to other display devices, i.e. monitor, which can only display images by a fixed sized, a projection system is more convenient and low cost in displaying large images.

The conventional projection system, i.e. a projector, uses white light lamps as the light source; by the means of the optical system inside the projector, the images can be projected on a screen or a wall. For clarity of the images projected out, the white light lamp has to be of high illumination and changed every one or two year so that it is inconvenient to the users. To overcome this problem, projectors using light-emitting diode (LED) have been developed. Life span of LED used for the light source is as much as twenty thousands hours. Compared to the conventional projectors using white light lamp as the light source, LED projectors can work for a long time without being out of order.

On the other hand, because of the miniaturization trend of electronic products these days, the projectors for displaying large-area images in the past have been developed into miniature projectors for individual users. The miniature projectors can be used as personal computer or television. Besides, the LED projector mentioned above can also be miniature projector for individual users, the size is even fit for being accommodated in the pocket and portable, which is convenient for the users.

However, while miniaturizing the projectors, their internal room for accommodating components is getting smaller; the path of the light emitted by the light source of the projector inside the projector is getting shorter. Because of the limits of the standards of optical system (such as various lenses) of the conventional projectors, when the volume of the projector is reduced, the exit pupil formed by the optical system will deviate from the entrance pupil of the projection lens, resulting in light blocked behind the projection lens and unable to project out the projector, therefore light efficiency is reduced. In order to maintain a desirable illumination, the light source should emit higher luminance light so that the projector consumes more energy and the components inside consumes rapidly; the heat produced is also increased so that thermal scattering problem becomes more serious.

### SUMMARY OF THE INVENTION

It is an object of the present invention to provide a projection system which can improve light efficiency by the means of a field lens.

According to an embodiment, the projection system of the present invention includes a light source, a light gathering device, an imaging device and a projection lens. The light source can emit a first light. The light gathering device includes an aperture and a lens, the aperture and the lens receive the first light in sequence and produce a second light emitting from the light gathering device. The imaging device includes a field lens and a reflective valve near the field lens. The field lens and the reflective valve can receive the second light in sequence, and form an exit pupil through refraction and reflection. The projection lens has an entrance pupil, the entrance pupil substantially overlap the exit pupil formed by the field lens and the reflective valve of the imaging device in the light path.

In the present embodiment, a size of the entrance pupil is substantially the same with or greater than a size of the exit pupil; furthermore, because that the entrance pupil substantially overlap the exit pupil, the light emitted from the light source, passing through the light gathering device and the imaging device will be within the range of the entrance pupil and be received by the projection lens which consequently projects the light out the projection system. As a result, the projection system of the present invention has good light use efficiency.

The advantages and spirit of the present invention can be further understood from the following detailed description and drawings.

### BRIEF DESCRIPTION OF THE DRAWINGS

FIG. 1 is a schematic view of the projection system of the embodiment of the present invention;

FIG. 2 is a schematic view of the equivalent field lens formed by the field lens and the reflective valve of the projection system shown in FIG. 1;

FIG. 3 is a schematic view of the projection system of another embodiment of the present invention;

FIG. 4 is a schematic view of the projection system of another embodiment of the present invention; and

FIG. 5 is a schematic view of the projection system of another embodiment of the present invention.

### DETAILED DESCRIPTION OF THE PREFERRED EMBODIMENT

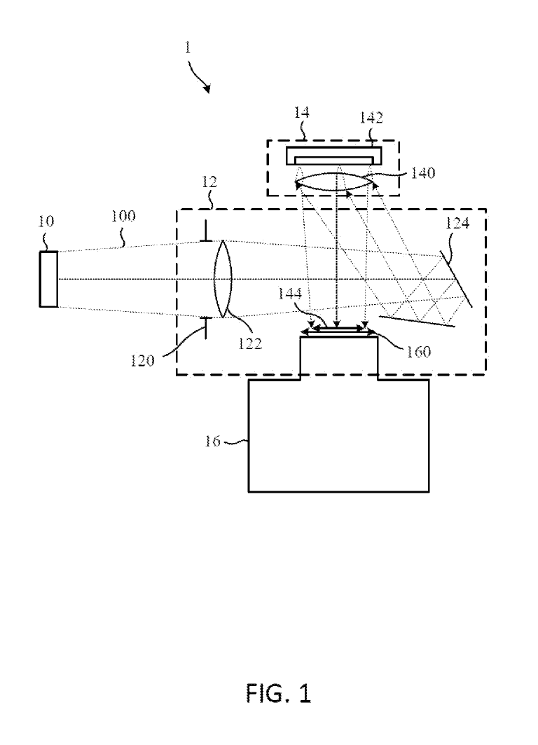

Please refer to FIG. 1, which is a schematic view of the embodiment of a projection system 1 of the present invention. As FIG. 1 shows, the projection system 1 comprises a light source 10, a light gathering device 12, an imaging device 14 and a projection lens 16.

In the embodiment, the light source 10 is used for emitting light. In practice, the light source 10 is a body light source or preferably a planar light source, such as a light-emitting diode. The light 100 emitted from the light source 10 is projected to the light gathering device 12, the light gathering device 12 includes an aperture 120 and a lens 122, wherein the lens 122 is close to the aperture. As FIG. 1 shows, the light 100 passes through the aperture 120 and the lens 122 in sequence. Besides, the light gathering device 12 can further includes a light path changing unit 124. The light 100 passing through the aperture 120 and the lens 122 can reach the light path changing unit 124 where a light path is changed by the light path changing unit 124. In the present embodiment, the light path changing unit 124 is composed of two reflector mirrors; in practice, however, the number and the disposition site of the reflector mirrors are decided based on the users' or the designers' necessity and not limited to the present embodiment.

The light 100 from the light path changing unit 124 can reach the imaging device 14. The imaging device 14 comprises a field lens 140 and a reflective valve 142 near the field lens; in practice the reflective valve 142 can be a digital micromirror device (DMD) or other similar reflective microdisplay panel which is not limited to the present invention. The light 100 from the light gathering device 12 will first pass through the field lens 140 to reach the reflective valve 142 where the light 100 is made an image beam by the reflective valve 142 and then reflected to pass through the field lens 140 again. Because the aperture 120 limits the amount of the light 100 which is passing through the aperture 120 from the light source 10, the imaging device 14 will produce an exit pupil 144 in space depending on the position of the aperture 120; in other words, the position of the exit aperture 144 is determined by the positions of the aperture 120, the lens 122, the field lens 140, and the reflective valve 142 in the light path and imaging parameters therein.

The projection lens 16 has an entrance pupil 16, wherein the entrance pupil 16 represents the extent to which the projection lens 16 can accept the light 100. In practice, because the projection lens 16 itself has definite optical standards so that the entrance pupil 160 also has a definite size and a position relative to the projection lens 16. In the present embodiment, the units inside the projection system 1 can be designed to allow the position of the entrance pupil 160 of the projection lens 16 substantially overlap the exit pupil 144, which is produced by the imaging device 14. Besides, the size of the entrance pupil 160 is greater than or substantially equal to the size of the exit pupil. After being refracted and reflected by the imaging device 14, because the size of the entrance pupil 160 is greater than or equal to the size of the exit pupil 144 and substantially overlaps the exit pupil 144, the light 100 will pass through the entrance pupil 160 thoroughly and be accepted by the projection lens 16; after that, the projection lens 16 projects the light out the projection system 1. As mentioned above, through the field lens 140 and the reflective valve 142 of imaging device 14, the light 100 emitted by the light source 10 can be accepted completely by the projection lens 16; therefore light use efficiency of the projection system 1 is improved.

Besides, as a result of the functions of the field lens 140 of the imaging device 14, a distance of the light 100 passing inside the projection system 1 is smaller than of the distance the light passing inside the conventional projection system. Therefore, a volume of the projection system of the present invention is consequentially reduced.

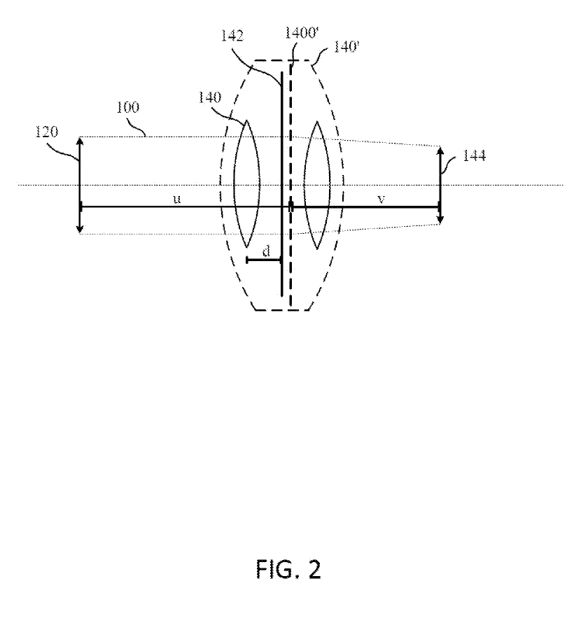

Please refer to FIG. 2, which is a schematic view of an equivalent field lens 140′ formed by the field lens 140 and the reflective valve 142 of the projection system 1 shown in FIG. 1. When the light 100 from the light gathering device 12 reaches the imaging device 14, the light 100 will first pass through the field lens 140 and reach the reflective valve 142, and then be reflected by the reflective valve 142 to pass again through the field lens 140. In FIG. 2, for the reason of clarity, light passing through the field lens 140 twice is presented with two field lens 140 symmetrically at two sides of the reflective valve 142. Besides, in the present embodiment, a distance between the field lens 140 and the reflective valve 142 is d.

As FIG. 2 shows, the circumstance that the light 100 mentioned above reaches the reflective valve 142 after passing through the field lens 140 and is reflected by the reflective valve 142 to pass through the field lens 140 again can be regard as the light 100 passing through an equivalent field lens 140′. The equivalent field lens 140′ of the present embodiment has a main plane 1400′, a distance between the main plane 1400′ and the aperture 120 of the light gathering device 12 can be defined as u (object distance), meanwhile, a distance between the main plane 1400′ and the exit pupil 144 can be defined as v (image distance). Please note that in the present embodiment, the aperture 120 is near the lens 122, as a result, a distance between the lens 122 and the main plane 1400′ is substantially equal to u.

In order to improve the light use efficiency, the light 100 from the light gathering device 12 passing through the field lens 140 is made to be thoroughly reflected by the reflective valve 142. As a result, an aspect ratio of the reflective valve 142 has to substantially the same with an aspect ratio of an emitting area of the light source, and then the light 100 is able to be totally reflected efficiently. Besides, focal length of the lens 122, F₂, is able to be approximate to the distance u; by the means, the light 100 passing through the lens 122 can efficiently focus on the imaging device 14 and further be totally reflected by the reflective valve 142. If focal length of the lens 122, F₂ is greater or smaller than the distance u, the light 100 will disperse when reaching the imaging device 14 and be unable to be totally reflected by the reflective valve 142, resulting in light loss.

As FIG. 1 and FIG. 2 show, in the present embodiment, the distance, u, from the aperture 120 and the lens 122 to the main plane 1400′ is greater than the distance v from the main plane 1400′ to the exit pupil 144, namely v/u<1, thereby the volume of the projection system 1 can be efficiently reduced.

In the present embodiment, the field lens 140 is a thin lens having focal length F₁, and a distance between the field lens 140 and the reflective valve 142 is d, therefore, the equivalent field lens 140′ in FIG. 2 has focal length F′=F₁²/(2F₁−2d). Furthermore, according to thin lens equation 1/F′=(1/u)+(1/v), M=v/u and the equivalent field lens equation above, wherein M is the amplification ratio, the size and the position of the exit pupil 144 can be determined by a design of the field lens' focal length and the distance d between the exit pupil 144 and the reflective valve 142, then the exit pupil 144 is substantially made to overlap the entrance pupil 160 of the projection lens 16, wherein the size of the exit pupil 144 is controlled to be smaller than or equal to the size of the entrance pupil 160.

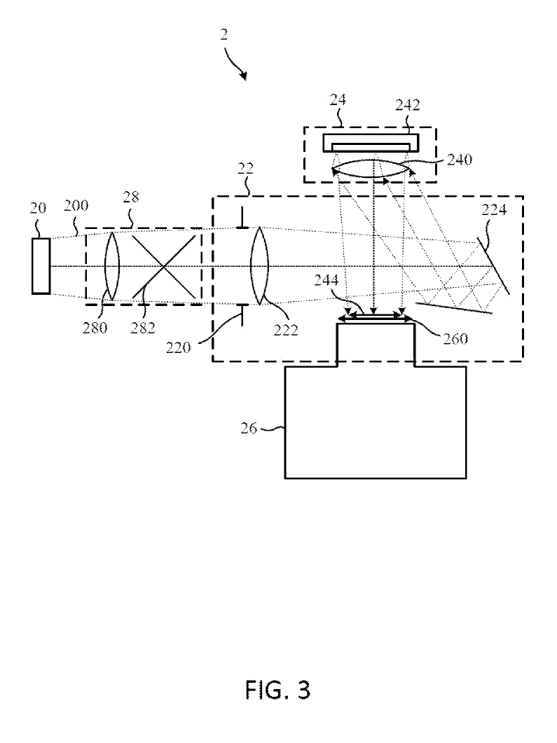

Please refer to FIG. 3, which is a schematic view of a projection system 2, includes another embodiment of the present invention. As FIG. 3 shows, the projection system 2 of the present embodiment includes a light source 20, a light gathering device 22, an imaging device 24, a projection lens 26 and a collimation device 28, wherein the collimation device 28 is for receiving a light 200 emitted by the light source 20 and letting the light 200 be a parallel light. Please note that the other units of the projection system 2 of the present embodiment is substantially the same with the corresponding units of the last embodiment, unnecessary details would not be given here.

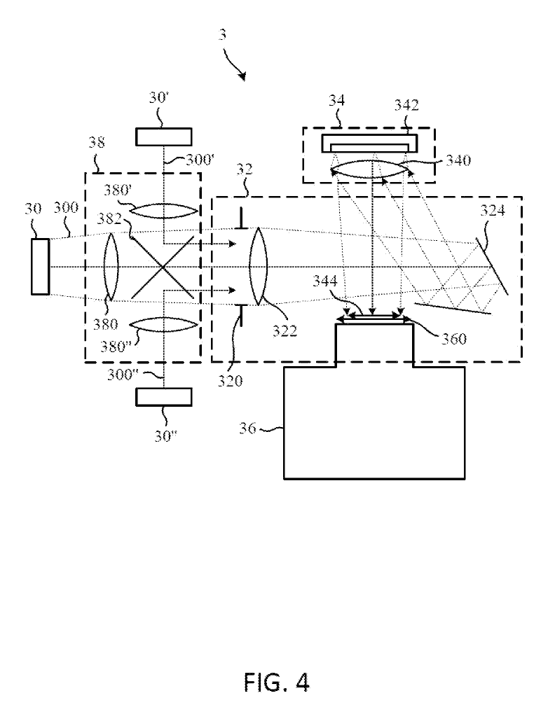

The collimation device 28 includes a collimator lens 280 and a splicer 282 for adjusting the light 200 to a parallel light. Besides, splicer can mix lights emitted by different light sources. For example, please refer to FIG. 4, which is a schematic view of a projection system 3 of another embodiment of the present invention. As FIG. 3 shows, the projection system 3 has a first light source 30, a second light source 30′ and a third light source 30″; the collimation device 38 has a first collimator lens 380, a second collimator lens 380′ and a third collimator lens 380″ which respectively receives a first light 300, a second light 300′ and a third light 300″, and then the first light 300, the second light 300′ and the third light 300″ are mixed to a parallel light projecting to the light gathering device 32. For example, the three light source can respectively R, G, or B color light-emitting diode which emits one of the three color lights, the three color lights are mixed by the splicer to form a parallel light projecting to the light gathering device; by the means of adjusting ratio of the three color lights, it's able to adjust color of the light which is received by a projection lens 36. Similarly, the other units of the projection system 3 of the present embodiment is substantially the same with the corresponding units of the embodiment mentioned above, unnecessary details would not be given here.

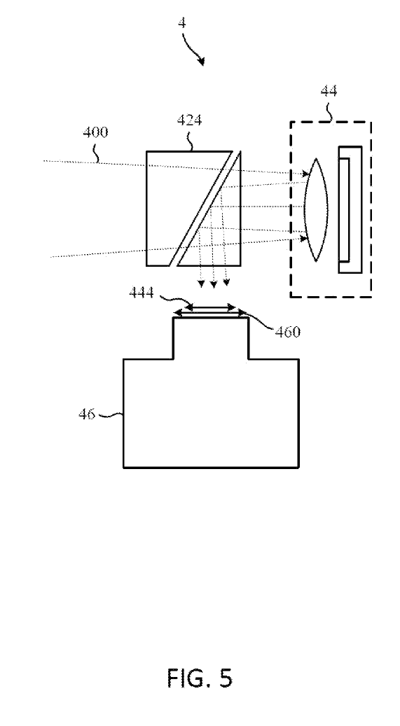

Please refer to FIG. 5, which is a schematic view of a projection system 4 of another embodiment of the present invention. As FIG. 5 shows, the difference between the present embodiment and the embodiments mentioned above is that, a light path changing unit 424 is a total reflection prism; by the means of a total reflection prism, an exit pupil 444 can be formed to substantially overlap an entrance pupil 460 of the projection lens 46. Please note that for clarity, the other units of the projection system 4 are not shown in FIG. 5, besides, the other units of the projection system 4 of the present embodiment is substantially the same with the corresponding units of the last embodiment.

In the present embodiment, a light 400 emitted from a light source (not showed in FIG. 5) passes through an aperture and a lens (not showed in FIG. 5), a light path changing unit 424, and then reaches an imaging device 44. A reflective valve 442 of the imaging device 44 can reflect the light 400 and let it go back to the light path changing unit 424. After that, the light path changing unit 424 changes a direction of the light 400 and let the light 400 be toward a projection lens 46 to be formed an exit pupil 444 near an entrance pupil 460 of the projection lens 46.

Compared to the prior art, the projection system of the present invention forms the exit pupil near the entrance pupil of the projection lens by the imaging device having the filed lens and the reflective units, furthermore the size of the exit pupil is smaller that the size of the entrance pupil. Therefore the light emitted from the light source can be received by the projection lens completely by the means of the filed lens and the reflective units, and then light use efficiency of the projection system is improved. Besides, by manipulating focal length of the filed lens and the distance between the field lens and the reflective units, the position and the size of the exit pupil can be adjusted and then the light path in the projection system can be reduced. As a result, the projection system volume can be also reduced and is suitable for be an individual type projector.

Although the preferred embodiments of present invention have been described herein, the above description is merely illustrative. The preferred embodiments disclosed will not limited the scope of the present invention. Further modification of the invention herein disclosed will occur to those skilled in the respective arts and all such modifications are deemed to be within the scope of the invention as defined by the appended claims.

What is claimed is:

1. A projection system, comprising:
a light source for emitting a first light;
a light gathering device, comprising an aperture and a lens, the aperture and the lens receiving the first light in sequence and producing a second light emitted from the light gathering device;
an imaging device, including a field lens and a reflective valve near the field lens, the field lens and the reflective valve receiving the second light in sequence and producing an exit pupil; and
a projection lens having an entrance pupil, the entrance pupil substantially overlapping the exit pupil.

2. The projection system of claim 1, wherein the light gathering device further includes a light path changing unit for changing direction of the second light.

3. The projection system of claim 2, wherein the light path changing unit is composed of two reflector mirrors.

4. The projection system of claim 2, the light path changing unit is a total reflection prism.

5. The projection system of claim 1, wherein the reflective valve is a digital micromirror device.

6. The projection system of claim 1 further including a collimation device for receiving the first light, enabling the first light to form a parallel light.

7. The projection system of claim 6, wherein the collimation device further including a collimator lens and a splicer.

8. The projection system of claim 1, wherein the light source is a planar light source.

9. The projection system of claim 8, wherein the planar light source is a light-emitting diode.

10. The projection system of claim 1, wherein an aperture size is substantially the same with a lens size.

11. The projection system of claim 1, wherein an aspect ratio of the reflective valve is substantially the same with an aspect ratio of an emitting area of the light source.

12. The projection system of claim 1, wherein the aperture is near the lens.

13. The projection system of claim 1, wherein the size of the entrance pupil is greater than or equal to the size of the exit pupil size.

14. The projection system of claim 1, wherein the field lens and the reflective valve together form an equivalent field lens for producing the exit pupil, the field lens, the reflective valve, and the equivalent field lens equivalent to that the field lens and the reflective valve receive the second light in sequence, and the reflective valve reflects the second light to the field lens.

15. The projection system of claim 14, wherein the equivalent field lens has a main plane, a distance between the main plane and the aperture is defined as u, a distance between the main plane and the exit pupil is defined as v, and v/u<1.

16. The projection system of claim 15, wherein focal length of the lens is substantially equal to u.

17. An projection system, comprising:
an aperture;
a first lens close to the aperture;
a light path changing unit;
a field lens;
a reflective valve near the field lens, a light passing through the aperture, the lens, and the light path changing unit in sequence, wherein the light direction is changed when passing through the light path changing unit to be projected on the reflective valve to produce a image beam, the image beam passes through the field lens to produce a exit pupil; and
a projection lens, the projection lens having an entrance pupil, the entrance pupil substantially overlapping the exit pupil.

18. The projection system of claim 17, wherein the field lens and the reflective valve together form an equivalent field lens for producing the exit pupil, the field lens, the reflective valve, and the equivalent field lens equivalent to that the field lens and the reflective valve receive the light in sequence, and the reflective valve reflects the image beam to the field lens.

19. The projection system of claim 18, wherein the equivalent field lens has a main plane, a distance between the main plane and the aperture is defined as u, a distance between the main plane and the exit pupil is defined as v, and v/u<1.
